(19) United States
(12) Patent Application Publication
(10) Pub. No.: US 2007/0169630 A1
(43) Pub. Date: Jul. 26, 2007

(54) THERMAL PROCESSING CHAMBER AND CONVEYOR BELT FOR USE THEREIN AND METHOD OF PROCESSING PRODUCT

(76) Inventor: David Auyoung, Vancouver (CA)

Correspondence Address: NEXUS LAW GROUP LLP, 1500 - 701 WEST GEORGIA STREET, VANCOUVER, BC, V74-1C6, CA

(21) Appl. No.: 11/307,062

(22) Filed: Jan. 20, 2006

(51) Int. Cl. A23L 1/00

(52) U.S. Cl. 99/275

(57) ABSTRACT

A thermal processing chamber having an endless conveyor belt providing a level surface for placement of products for thermal processing in the chamber. Thermal processing is completed through a combination of convection from impingement by a stream of thermally charged gas against the product and conduction between the conveyor belt and the product. The endless conveyor belt comprises a plurality of plates forming a flat, horizontal surface, each plate having a set of male and female linking elements, for linking with an adjacent plate so as to prevent misalignment of the plates.

### FIELD OF THE INVENTION

The present invention relates to a thermal processing chamber and a method for thermal processing of products being conveyed through the chamber. The invention further relates to a conveyer belt for use in the thermal processing chamber for form stabilizing the products during the thermal process. More specifically, the invention relates to a flat, endless conveyor belt providing a level surface for placement of products for thermal processing in the processing chamber, the processing chamber being adapted for the quick-freezing or heating of food products such as fish filets, chicken breasts or the like through a combination of thermal convection and impingement thermal conduction.

### BACKGROUND OF THE INVENTION

As the global population grows, food processing becomes ever more important. Pre-cooked and frozen food products are a staple in the prepared food industry. Freezing is also readily used to allow food to be shipped around the world in a preserved state and is particularly used in the fish and poultry industries.

Thermal processing chambers and methods for heating or freezing food products have existed for years. At its most basic, a thermal processing chamber comprises a conveyor for conveying a food product through a heating or freezing process (or both).

An example of such a thermal processing chamber is taught in U.S. Pat. No. 3,708,995 issued to Berg. Berg teaches a chamber equipped with a series of conveyors for conveying food to be frozen. Liquid CO₂ is circulated in the chamber by a plurality of circulating blowers (fans) in order to freeze the food products. The fans are mounted in a vertical orientation on the side of the conveyor such that the flow of air from the fans is from the side of the conveyors. Because the flow of air is from the side, it does not effectively remove the boundary layer that coats the food product resulting in inefficient cooling of the product and reduced quality of the frozen product. Slower freezing will yield a lower product as larger ice crystals form in the food product which causes cell lysis. When the food product is defrosted, the cells are destroyed and the intracellular fluid is lost. In addition, slower freezing results in greater dehydration which therefore results in a lower quantity of product by weight.

In order to overcome problems associated with the boundary layer, impingement freezers were developed. For example, U.S. Pat. No. 5,551,251 issued to Ochs et al. teaches a tunnel freezing system having a plurality of high velocity refrigerated air impingement jets to quick freeze food products. The impingement jets are in blocks that are located in air ducts, the air ducts being located above and below a conveyor belt for conveying the food products through the freezer. The refrigerated air is forced through the impingement jets against the tops and bottoms of the food products, breaking apart the boundary layer of air on the food product surface. By breaking away the boundary layer, the impingement freezer increases the rate of convection heat transfer between the food product and the refrigerated air, thereby reducing dehydration of the food product as compared to non-impingement mechanical freezing methods.

The impingement freezers, however, do suffer from deficiencies. In order to allow the refrigerated air from the impingement jets to come into contact with the food product, the conveyors of the prior art impingement processors have an open structure. The refrigerated air passes through the open structure of the conveyor and cools the food product. This open structure for the conveyor results in damage to the food products prior to freezing, such as unwanted markings on the food product, lost food material trapped in rough edges of the conveyor, deformation of the food product and the like; such damage resulting in a lowered value of the food product. In addition, this system is not suitable for freezing products having a liquid component, as the liquid would flow through the conveyor openings. Furthermore, a purely impingement freezer would be more expensive as it would be a larger system.

Additional thermal processing designs have been developed in an effort to further improve the quality of the food product being processed. U.S. Pat. No. 6,825,446 issued to Arnarson et al. teaches a thermal processing chamber utilizing a combination of thermal convection from the surrounding air and thermal conduction from a conveyor belt, preferably made of aluminum with a Teflon® coating. The thermal processing chamber has a form freezing endless conveyor belt made from a plurality of elongated beams having a wing shaped cross-sectional shape. The beams have two orientations—a first orientation in the processing portion of the endless conveyor loop wherein the trailing edge of an elongated beam rests on the leading edge of the following elongated beam forming a continuous horizontal surface; and a second orientation in the idling part of the conveyor loop wherein each beam freely hangs vertically downwards. A thermally charged stream of air is directed from the side of the conveyor belt, partly over the belt and partly below the belt. While the combination of conduction and convection results in improved thermal processing, because the thermally charged air is directed from the side it does not break the boundary layer around the food product. In addition, after repeated use, the Teflon® coating will crack rendering the aluminum conveyor belt unacceptable for food processing (food products cannot be placed directly on aluminum), requiring replacement with consequent maintenance costs.

Difficulties have also been encountered in developing a suitable conveyor for food products. As discussed above, impingement thermal processors are most efficient when an open conveyor is used which allows the thermally charged air to pass through the conveyor and come into contact with the food product. However, open conveyors cause damage to the food product. Flat conveyors have also been designed, typically in the form of a plurality of horizontal slats forming a horizontal surface. However, these flat conveyors are not without their deficiencies: they can also cause damage to food products, usually as a result of gaps between adjacent slats, especially when the slats move around the sprockets at either end of the endless conveyor.

One solution to limit the amount of separation between the top surfaces of adjacent slats has been to have the pivot point of the slats positioned to correspond to the top outer edge of the slats and to have the slats taper from top to bottom so that the slats will not come into contact with one another while rounding the sprocket. Two such slat conveyors are taught in U.S. Pat. Nos. 4,326,626 issued Apr. 27, 1982 to Brockwell and 4,526,271 issued Jul. 2, 1985 to Finnighan. One of the problems encountered with the slat conveyors has been with respect to bending of the slats. This is particularly true with larger conveyors. Finnighan attempts to overcome this problem by providing each slat with a supporting rod in the shape of a shallow V extending along the underside of the plate of the slat. However, the thin slat of Finnighan is not suitable for use in conducting heat to a food product as it is not thick enough to be capable of storing sufficient heat energy. Another problem encountered by large conveyors that are subjected to extreme temperatures is the deformation of the slats and consequent problems with maintaining the alignment of adjacent slats

Accordingly, there remains a need for a flat conveyor belt that is suited for conduction and is adapted to maintain the alignment of adjacent slats and provide a substantially flat surface for the placement of product to be processed. There is also a continuing need for an improved thermal processing chamber utilizing both conduction and convection in order to process a product.

It is therefore an object of an embodiment of the invention to provide a thermal processing chamber using both impingement convection and conduction to thermally process a food product.

It is a further object of an embodiment of the invention to provide an improved flat conveyor belt.

### SUMMARY OF THE INVENTION

The present invention comprises a thermal processing chamber having an endless conveyor belt providing a level surface for placement of products for thermal processing in the chamber. Thermal processing is completed through a combination of convection from impingement by a stream of thermally charged gas against the product and conduction between the conveyor belt and the product. The endless conveyor belt comprises a plurality of plates forming a flat, horizontal surface, each plate having a set of male and female linking elements for linking with an adjacent plate so as to prevent misalignment of the plates.

According to an embodiment of the invention there is provided a thermal processing chamber for thermally processing products comprising an insulated housing defining an enclosure having an infeed area and an outfeed area. A conveyor is mounted within said enclosure for conveying the products from the infeed area through the chamber to eventually be discharged through said outfeed area. The processing chamber is equipped with thermal processing means for thermally charging a gas and delivering it against the topside of the products and conveyor at a high velocity to impinge the topside of the products and conveyor. The conveyor is formed of a thermal energy conducting material, such that thermal processing of the products occurs as a result of the combination of thermal conduction between the conveyor and the products and by convection between the thermally charged gas and the products.

The thermal processing means comprises charging means for thermally charging the gas within the housing enclosure, a fan for drawing gas through the charging means into an intake chamber, and an impingement compartment. The fan draws gas from the intake chamber, delivering it under pressure to the impingement compartment, which directs the pressurized gas towards the product and conveyor for impingement thereof.

In another aspect, the impingement compartment comprises a plurality of alternating impingement ducts and pressure release channels, each of the impingement ducts having a removable tray. The tray has a plurality of holes defined therein, which the pressurized gas pass through at a high velocity.

In another aspect, the conveyor comprises a plurality of thermal energy conducting slats mounted about a pair of sprockets, each slat bounded at each end by a chain link, the chain links being pivotally connected one to another at a pivot point thereby joining the slats.

Each of said slats comprises an elongated plate having a top planar surface and sides tapering to a lower surface. The edges of the top surfaces of adjacent slats are in abutment. The edges of the top surface of each slat are located at the pivot points between adjacent chain links.

In another aspect, each of the slats further comprises a set of linking elements. The linking elements comprise a longitudinally extending bar and a slot, the bar being sized to fit within the slot of an adjacent slat and to move within the slot when adjacent slats travel about the sprockets. The bar is mounted on a pair of spaced non-tapered portions and the slot extends into a corresponding single non-tapered portion. The single non-tapered portion is sized to fit between the spaced non-tapered portions.

In another aspect, the thermal processor further comprises a secondary conveyor positioned below said conveyor and a slide, said product traveling from the conveyor down the slide to the secondary conveyor for further thermal processing by way of convection before exiting the thermal processor at the outfeed area.

According to an alternative embodiment of the invention there is provided a conveyor for use in a thermal processing chamber for thermally processing a product. The conveyor comprises a plurality of thermal energy conducting slats, each slat bounded at each end by a chain link, chain links on adjacent slats being pivotally connected one to another thereby joining the slats. A pair of drive sprockets is mounted on a frame, the chain links being mounted about the sprockets such that the slats form an endless loop. Each of the slats has a set of linking elements comprising a male element insertable within a female element.

Each of said slats of the conveyor comprises an elongated plate having a top planar surface and sides tapering to a lower surface. The slats are connected to the chain links such that the edges of the top surface of each slat are located at the pivot points between adjacent chain links. The edges of the top surfaces of the slats are in abutment.

In another aspect of the conveyor, the linking elements comprise a longitudinally extending bar and a corresponding slot, the bar being sized to fit within the slot of an adjacent slat and to move within the slot when adjacent slats travel about the sprockets. The bar is mounted on a pair of spaced non-tapered portions and the slot extends into a corresponding single non-tapered portion, the single non-tapered portion sized to fit between the spaced non-tapered portions.

According to a further alternative embodiment of the invention there is provided a method of thermally processing a product using the thermal processing chamber described above comprising the steps of placing a product on the conveyor and conveying the product within the processing chamber, the product being subjected to thermal conduction with the conveyor and to thermal convection from the thermally charged air, the thermally charged air impinging the product

The foregoing was intended as a broad summary only and of only some of the aspects of the invention. It was not intended to define the limits or requirements of the invention. Other aspects of the invention will be appreciated by reference to the detailed description of the preferred embodiment and to the claims.

### BRIEF DESCRIPTION OF THE DRAWINGS

These and other features of the invention will become more apparent from the following description in which reference is made to the appended drawings and wherein:

FIG. 1 is a sectional view from the right side of the preferred embodiment of a thermal processing chamber according to the invention;

FIG. 2 is a sectional view from the front of a thermal processing chamber taken along line 2-2 shown in FIG. 1;

FIG. 3 is a sectional view from the top of a thermal processing chamber taken along line 3-3 shown in FIG. 2 with the access doors in an open position;

FIG. 4 is a sectional view from the top of a thermal processing chamber taken along line 4-4 shown in FIG. 2 with the access doors in an open position;

FIG. 5 is a sectional view of a portion of an impingement chamber and an upper conveyor belt having food product placed thereon;

FIG. 6 is a perspective view of a portion of the impingement chambers of the thermal processor;

FIG. 7A is a sectional view of a portion of the upper conveyor traveling about a sprocket;

FIG. 7B is a perspective view of a portion of the endless conveyor with a portion magnified to show the linking elements between slats of the conveyor;

FIG. 8A is a top view of a slat of the conveyor for use in the thermal processor shown in FIG. 1;

FIG. 8B is a bottom view of the slat shown in FIG. 8A;

FIG. 9 is a cross-sectional view of the slat shown in FIG. 8A taken along line 9-9;

FIG. 10 is a perspective view of two conveyor slats taken from the bottom left; and

FIG. 11 is a perspective view of two conveyor slats taken from the bottom right.

### DETAILED DESCRIPTION OF THE PREFERRED EMBODIMENTS

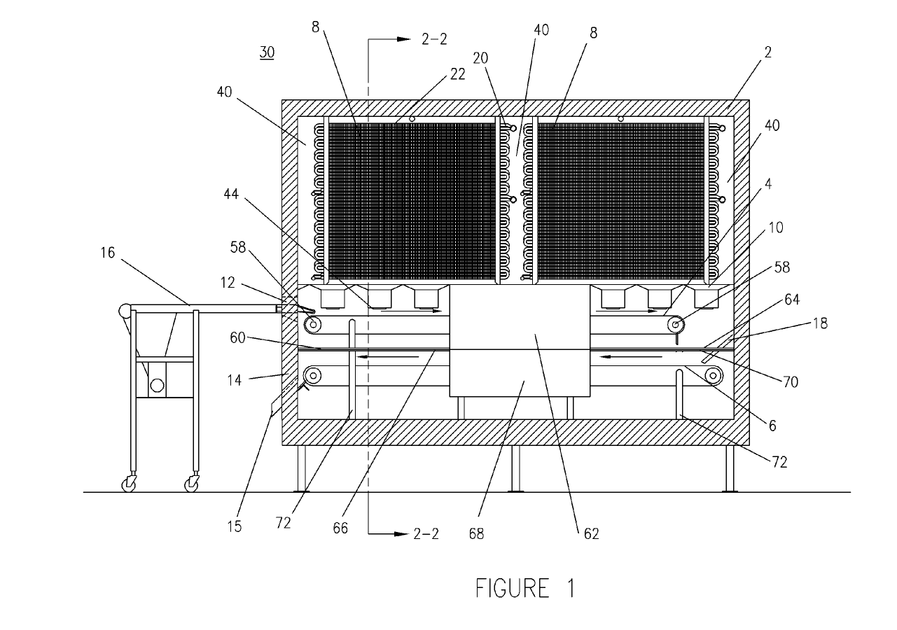

The preferred embodiment of a thermal processing chamber according to the invention generally referred to as reference numeral 30 is shown in FIG. 1. Referring to FIG. 1, it can be seen that the thermal processing chamber 30 generally comprises a housing 2, preferably formed of stainless steel with polyurethane insulation, defining a chamber or tunnel within which food products are thermally processed while traveling along an upper conveyor 4 through a combination of convection and conduction.

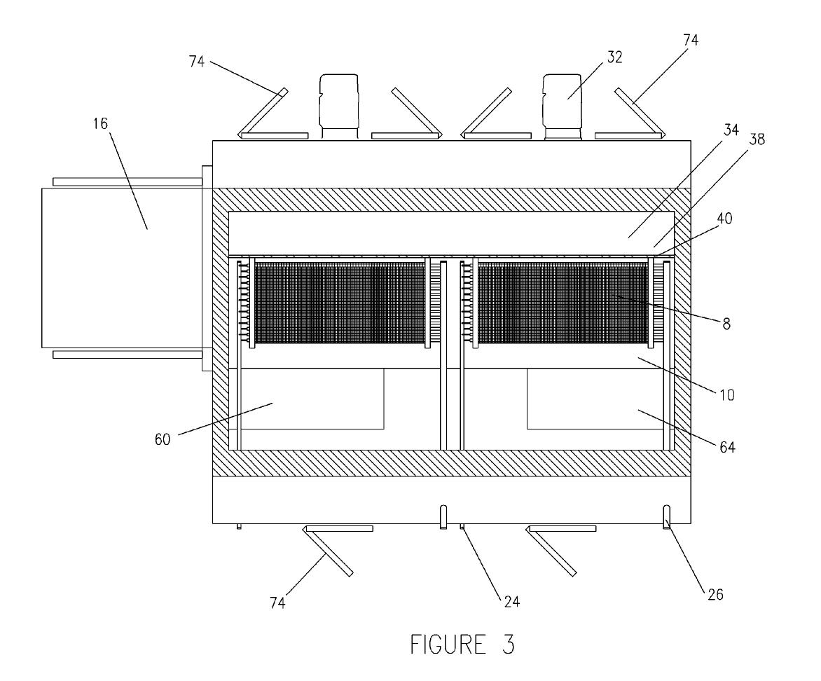

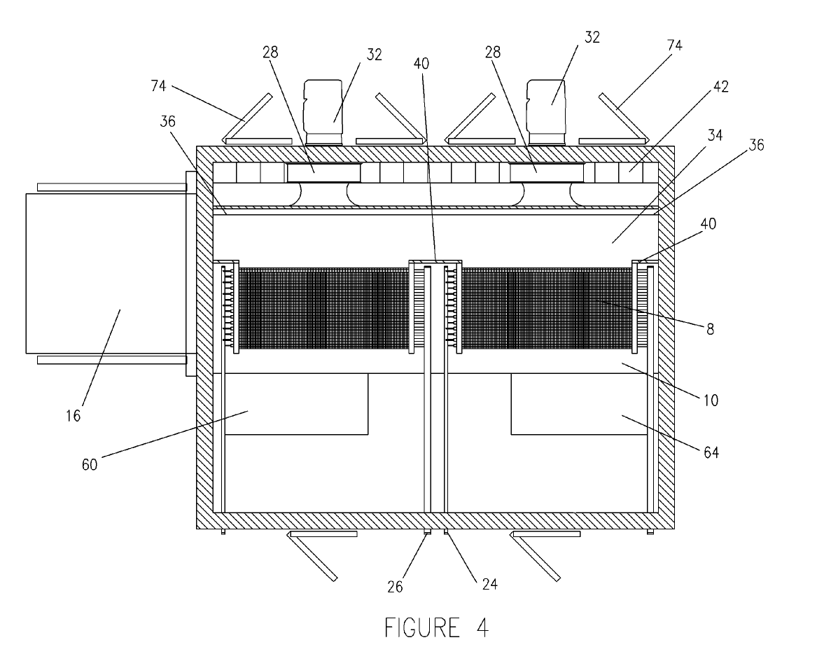

Referring to FIGS. 1-4, the processing chamber is also preferably equipped with a lower conveyor 6, both conveyors mounted on a conveyor frame 72 and powered by a power source. Processing chamber 30 has an infeed area 12 and an outfeed 14. The size of the openings of the infeed area 12 and the outfeed 14 is minimized so as to ensure the temperature within the interior of the processing chamber 30 is not affected. As shown in the preferred embodiment of the processing chamber 30, the upper conveyor is preferably contained within the confines of the processing chamber. Products to be thermally processed are fed onto the upper conveyor 4 by way of an infeed conveyor 16. Alternatively, the upper conveyor could extend out of the processing chamber a small amount to allow placement of product directly on it.

The upper conveyor 4 is formed of a relatively thick heat conducting material, preferably stainless steel, which acts as a thermal battery as described in more detail below. When a product comes into contact with the upper conveyor, heat energy is transferred between the product and the conveyor belt by way of conduction. Thermally charged air is also blasted onto the product cooling it via convection as discussed in greater detail below. Products placed on the upper conveyor are quickly cooled through the combination of conduction and impingement convection cooling eventually developing a form stable partly frozen shell. While the time to achieve the form stable state varies by product, it typically takes approximately 1-3 minutes at a temperature of minus forty (−40) degrees Celsius. The speed of the upper conveyor 4 is altered to provide the food products sufficient time to achieve the form stable state before reaching the end of the upper conveyor 4. At the end, products drop onto a slide 18 leading to lower conveyor 6. The products travel along lower conveyor 6 for a sufficient period of time to finish freezing. On the lower conveyor 6, the food can be stacked or in contact with other products and cooled to the required equilibrated temperature, the amount of time to do so again varying by product. Full freezing can range from 6 minutes to 60 minutes depending on the thickness of the product and its moisture content. The full frozen food products leave the chamber through the outfeed area 14, sliding down a chute 15 to another conveyor (not shown) where it is transported away for further processing or packaging.

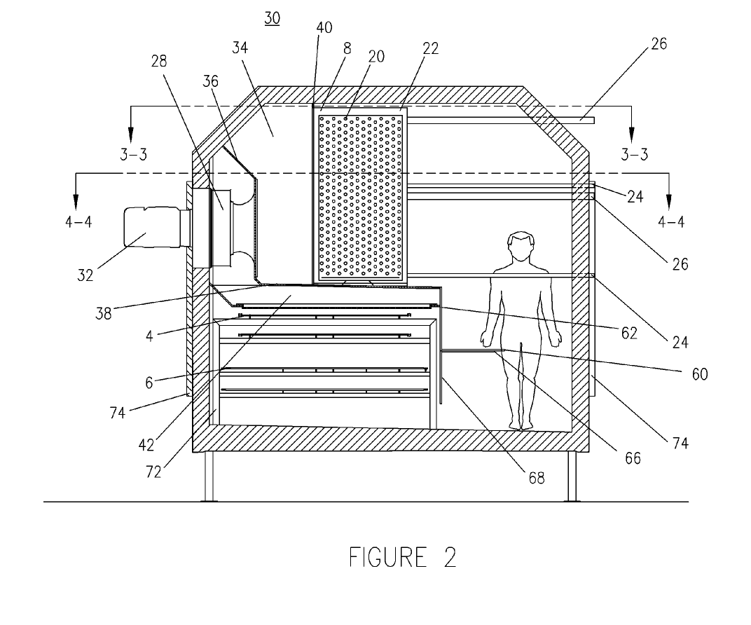

Cooling of the processing chamber is accomplished by way of a pair of evaporators 8 mounted atop an impingement compartment 10. The evaporators comprise a network of metal tubes 20 and aluminum fins 22. The evaporators 8 cool the chamber 30 by evaporation of CFC gases or by ammonia compressed by a compressor, or like method. Preferably, cooling is accomplished by way of an ammonia system. Ammonia gas is compressed at high pressures to a liquid state. The compressed ammonia is a hot gas which is cooled externally by a condenser (not shown) until it changes state into a high pressure liquid. A throttling device decreases the pressure of the liquid ammonia entering the evaporator. The ammonia entering the evaporator is at a low temperature and is converted from liquid to gaseous state as it picks up heat from the surrounding environment. The gaseous ammonia is returned to the compressor to repeat the cycle. Referring to FIG. 2, ammonia enters the evaporator through infeed tube 24 and exits via outfeed tube 26.

Air is thermally charged (in this case cooled) by being drawn through the evaporators 8 into an intake chamber 34 by a pair of centrifugal fans 28 driven by electric motors 32. Intake chamber 34 is defined by a wall 36 shown best in FIG. 2 bordered at either end and at the top by housing 2 and at the bottom by the top 38 of impingement compartment 10 and by wall 40 located adjacent the evaporators on the side proximal to the fans 28 (shown best by reference to FIGS. 2-4) and the evaporators 8 themselves. Openings in wall 40 correspond to the location of the evaporators 8 allowing air to travel through the evaporators 8 into the intake chamber 34.

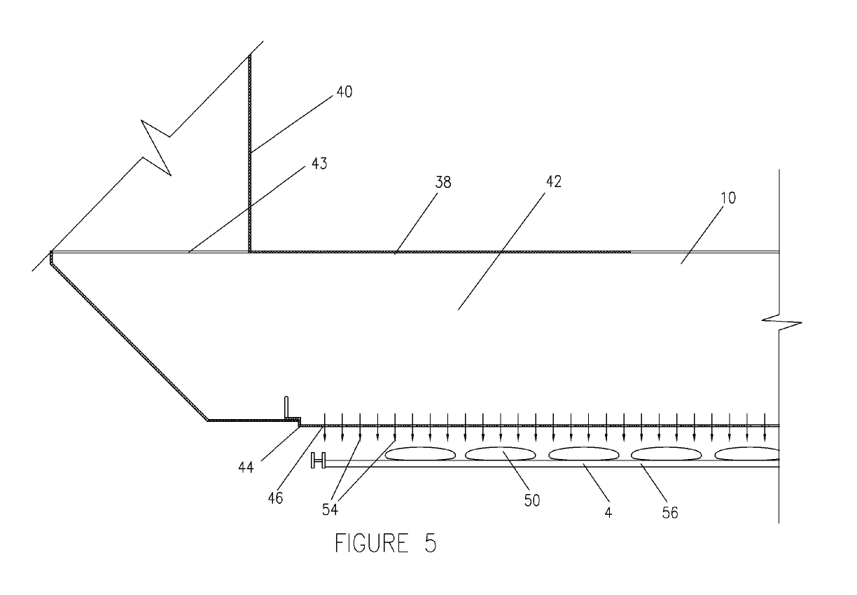

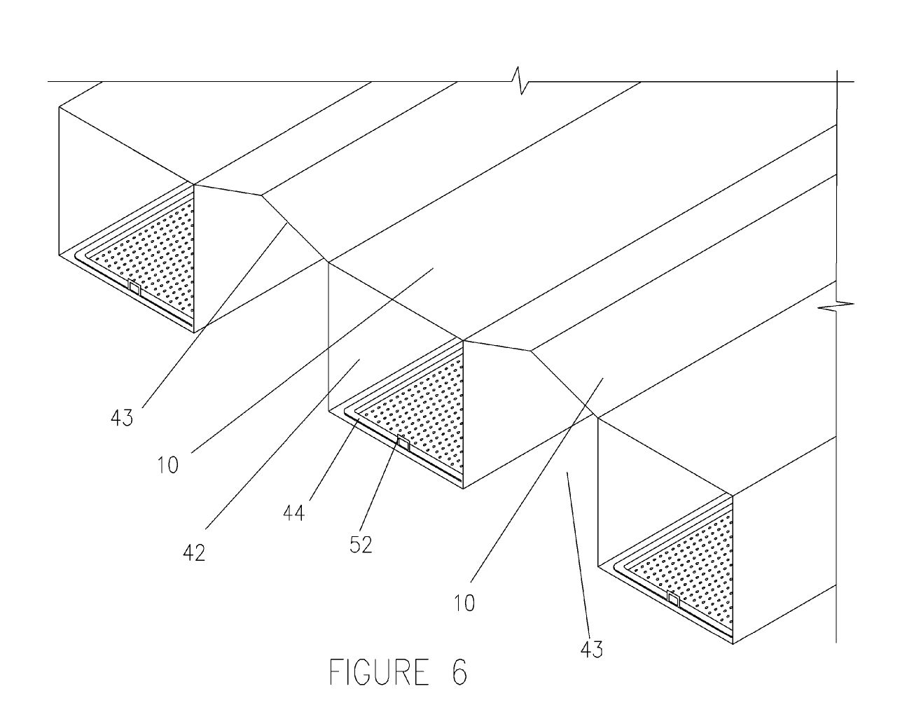

The cold air in the intake chamber 34 is drawn into the fans 28 and blown into the impingement compartment 10. Impingement compartment 10 has a plurality of impingement ducts 42 having holes 44 through which cold air from the fans is blown. Preferably, each impingement duct 42 is equipped with a removable tray 44 having holes 44 as shown best in FIGS. 5 and 6. A tab 52 connected to the tray can be grasped in order to lift the tray from its position in impingement duct 42. The trays are removable for cleaning purposes, and also so that different sized trays can be inserted in order to vary the distance between food products 50 and the holes 44 thereby optimizing the freezer for different products. Preferably the holes 44 are staggered such that each hole is equidistant from all adjacent holes, as this formation permits the closest distance between adjacent holes.

Between each impingement duct 42 is a pressure release channel 43. These release channels have open bottoms which provide space for the high pressure air from the impingement ducts to escape after being blown through holes 44.

As shown in FIG. 5, cold, pressurized air, represented by arrows 54 is forced through the small holes at high velocities, impacting perpendicularly against the top of the food product 50 and the top of the conveyor 4, thereby breaking the boundary layer and increasing the rate of cooling via convection. At the same time, heat energy is conducted from the food to the slats 56 of the upper conveyor 4, the conveyor having been cooled by convection through contact with the air. Referring again to FIGS. 1 and 2, a series of side covering plates 60, 62, 64, 66, 68 and 70 are visible. Upper side covering plates 60 and 64 are shown in the open position providing access to the upper conveyor 4 and the impingement channels 42. Upper side covering plate 62 is shown in the closed position. When in the closed position, the upper side covering plates 60, 62 and 64 act to seal the end of the impingement channels 42, preventing cold air from escaping. After striking the food product 50 and the slats upon which the food product 50 rests, the cold air flows into the pressure release channels 43 and around the lateral sides of the upper conveyor 4 down to the lower conveyor 6.

In FIG. 1, lower side covering plates 66 and 70 are shown in the open position, while lower side covering plate 68 is shown in the closed position. When in the open position, lower side covering plates 66, 68 and 70 provide access to the lower conveyor 6, while in the closed position they act to keep the cold air from the impingement compartment in the area of the conveyors. The upper side covering plates are hingedly connected to the conveyor frame 72 at their bottom end such that the tops of the plates pivot outward and downward. Conversely, the lower side covering plates are hingedly connected to the conveyor frame 72 at their top end such that the bottoms of the plates pivot outward and upward.

The processing chamber is equipped with a plurality of access doors 74, providing access to different parts of the chamber in order to allow it to be cleaned, inspected and maintained.

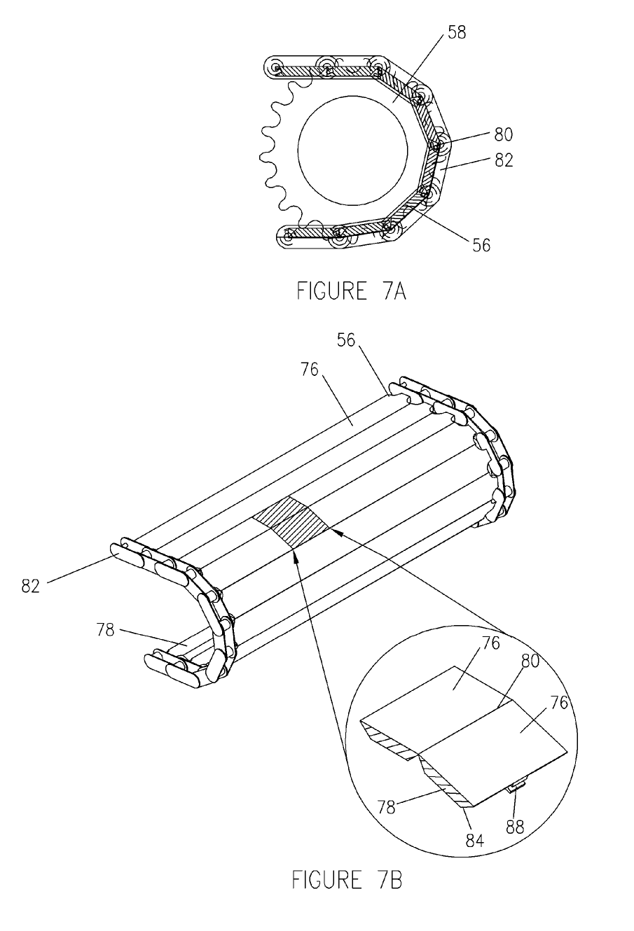

Referring to FIGS. 1 and 7, upper conveyor 4 is preferably formed of a plurality of metal slats 56 connected pivotally in a closed loop about a pair of sprockets 58. Preferably the slats are made from a material with a good thermal conductivity and approved for hygienic treatment such as stainless steel.

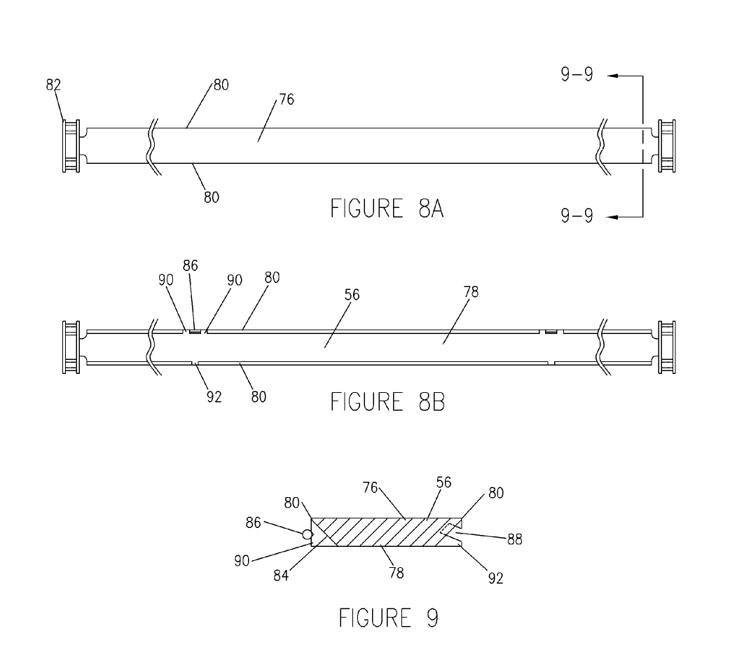

As shown in FIGS. 7-11, each of the slats 56 is an elongated plate having a top planar surface 76 and sides 84 tapering to a lower surface 78. Chain links 82 are welded to the ends of the slats and adjacent chain links pivotally connected to one another at a pivot point thereby connecting adjacent plates. The chain links are mounted about drive sprockets 58 for driving the conveyor, with the connected slats forming an endless loop. The ends of the slats are chamfered 57 in order to accommodate the chain links 82, which are composed of two repeated segments, on segment fitting into the other. The chamfered ends 57 are required so that there is clearance for the larger link. In addition, there is a bolt (not shown) connecting the links that extends beyond the edges of the link. The slats are connected such that the edges 80 of the adjacent upper surfaces are in abutment to one another so as to form a single solid surface along the top of the conveyor, with edges 80 located at the pivot point of the chain links 82 as shown in FIG. 7A. As the slats round the sprocket, the flat surface between adjacent slats is broken, resulting in release of items of food from the conveyor. Because the edges 80 are located at the pivot point between adjacent slats, there is minimal separation between the edges of adjacent slats ensuring minimal damage to product placed on the conveyor.

Each slat is equipped with linking elements to prevent misalignment of adjacent slats. The slats are produced with sides 84 tapering at a forty-five degree (45°) angle from the top planar surface 76 down to the lower surface 78 except at the locations of the linking elements, where the non-tapered portions form part of the linking elements. The linking elements are comprised of a male element and female element, the male element insertable within the female element as described in more detail bellow.

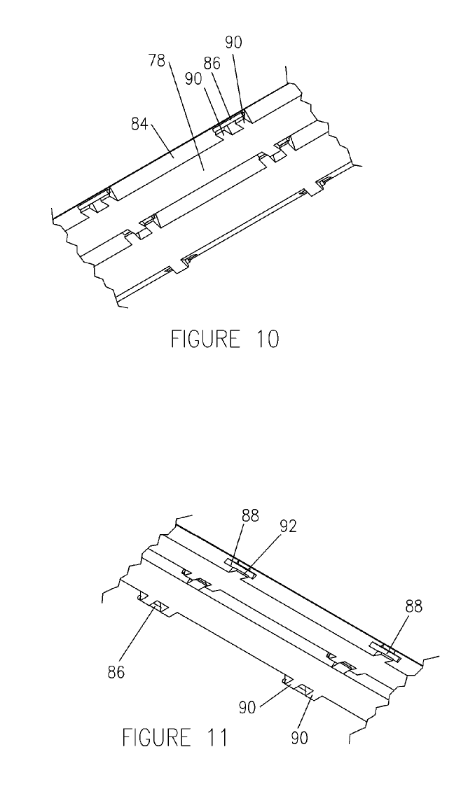

Preferably the linking elements comprise a reinforced longitudinally extending bar 86 connected to a pair of non-tapered portions 90 on one side and a corresponding slot 88 extending through a single non-tapered portion 92 and into the slat on the opposing side of each slat, the bar 86 and slot 88 being sized such that the bar fits in the slot and the single non-tapered portion 92 being sized to fit between the pair of non-tapered portions 90. When adjacent slats are attached to one another by way of the chain links 82, the bar 86 on one slat is inserted into the slot 88 of the adjacent slat. The slot is angled such that when the slats rotate around a drive sprocket 58 at either end of the conveyor, the bar 86 can move within the slot 88 so that alignment is maintained between slats. Preferably the slot is formed by machining of the metal slat as shown in FIGS. 9 and 11. The bar 86 is preferably connected to the pair of non-tapered portions 90 by welding as best shown in FIG. 10. Preferably the slot is angled such that the rod is able to move within the slot without binding when adjacent slats pivot relative to one another. The actual angle will vary depending on the size of the sprockets, chain links, slats and linking elements.

The linking elements do not need to be overly large in order to have the desired effect in maintaining alignment of adjacent slats. For example, with a slat that is two inches wide, five feet long and 0.375 inches thick, only two sets of linking elements set equidistant apart along the length of the slat are required to maintain alignment, the bar having a diameter of 0.125 inches and length of 1.375 inches and the slot being 1.375 inches. With a slat having these dimensions, the slot should be set at an approximately 22.5 degree angle relative to the top surface. Preferably there are at least 2 sets of linking elements per slat for slats equal or greater than five feet in length, with at least one set of linking elements for slats that are shorter than 5 feet.

Because food product 50 is in a form stable shape when it is transferred from the upper conveyor 4 to the lower conveyor 6, the lower conveyor need not be of the same type as the upper conveyor 4. Instead, any prior art belt having openings therein is suitable. Use of such a belt allows air arriving from above to flow through the belt, enveloping the food product as it is conveyed along the lower conveyor 6.

The conveyors are driven by frequency controlled electrical gear motors which work independently so that each of the conveyors can be run at different speeds. Variable Frequency Drives are used to control the speed of each gear motor.

For the purposes of this description, the thermal processing chamber described above was one designed for freezing food products such as raw chicken breast or fish fillets or the like through a combination of impingement convection cooling and cooling by conduction. It will be understood that the system could be reversed such that the processing chamber is equally adapted for heating food products with suitable modification (having a heater system rather than a cooling evaporator, injecting heated air rather than cooled air and installing a suitable grease disposal and cleaning system). It is also contemplated that other gases than air could be used.

It will be appreciated by those skilled in the art that the preferred and alternative embodiments have been described in some detail but that certain modifications may be practiced without departing from the principles of the invention.

What is claimed is:

1. A thermal processing chamber for thermally processing products comprising:
an insulated housing defining an enclosure and having an infeed area and an outfeed area;
a conveyor for conveying said products from said infeed area through said chamber,
thermal processing means for thermally charging a gas and delivering said thermally charged gas against the topside of said products and conveyor, said charged gas being delivered at a high velocity to impinge said topside of said products and conveyor;
wherein said conveyor is formed of a thermal energy conducting material, such that thermal processing of said products occurs as a result of the combination of thermal conduction between said conveyor and said products and by convection between said thermally charged gas and said products.

2. The thermal processing chamber of claim 1 wherein said thermal processing means comprises charging means for thermally charging said gas within the housing enclosure, a fan for drawing gas through said charging means into an intake chamber, and an impingement compartment, wherein said fan drawing gas from said intake chamber and delivering it under pressure to said impingement compartment and said impingement compartment directing the pressurized gas towards said product and conveyor for impingement thereof.

3. The thermal processor of claim 2 wherein said impingement compartment comprises a plurality of alternating impingement ducts and pressure release channels, each of said impingement ducts having a removable tray, said tray having a plurality of holes defined therein, said pressurized gas passing through said holes at a high velocity.

4. The thermal processor of claim 3 wherein said conveyor comprises a plurality of thermal energy conducting slats mounted about a pair of sprockets, each slat bounded at each end by a chain link, said chain links being pivotally connected one to another at a pivot point thereby joining said slats.

5. The thermal processor of claim 4 wherein each of said slats comprises an elongated plate having a top planar surface and sides tapering to a lower surface.

6. The thermal processor of claim 5 wherein the slats are connected to said chain links such that the edges of the top surface of each slat are located at the pivot points between adjacent chain links.

7. The thermal processor of claim 6 wherein the edges of the top surfaces of adjacent slats are in abutment.

8. The thermal processor of claim 7 wherein each of said slats further comprises a set of linking elements.

9. The thermal processor of claim 8 wherein said linking elements comprise a longitudinally extending bar and a slot, said bar being sized to fit within the slot of an adjacent slat and to move within the slot when adjacent slats travel about said sprockets.

10. The thermal processor of claim 9 wherein said bar being mounted on a pair of spaced non-tapered portions and said slot extending into a corresponding single non-tapered portion, said single non-tapered portion sized to fit between said spaced non-tapered portions.

11. The thermal processor of claim 10 further comprising a secondary conveyor positioned below said conveyor and a slide, said product traveling from said conveyor down said slide to said secondary conveyor for further thermal processing by way of convection.

12. The thermal processor of claim 11 wherein said means for thermally charging gas within the housing enclosure comprises an evaporator for cooling the gas.

13. A conveyor for use in a thermal processing chamber for thermally processing a product comprising:
a plurality of thermal energy conducting slats, each slat bounded at each end by a chain link, chain links on adjacent slats being pivotally connected one to another thereby joining said slats;
a pair of sprockets mounted on a frame, said chain links mounted about said sprockets such that said slats form an endless loop;
wherein each of said slats having a set of linking elements comprising a male element insertable within a female element.

14. The conveyor of claim 13 wherein each of said slats comprises an elongated plate having a top planar surface and sides tapering to a lower surface.

15. The conveyor of claim 14 wherein the edges of the top surfaces of adjacent slats are in abutment.

16. The conveyor of claim 15 wherein the slats are connected to said chain links such that the edges of the top surface of each slat are located at the pivot point between respective chain links.

17. The conveyor of claim 13 wherein said linking elements comprise a longitudinally extending bar and a corresponding slot, said bar being sized to fit within the slot of an adjacent slat and to move within the slot when adjacent slats travel about said sprockets.

18. The conveyor of claim 17 wherein said bar being mounted on a pair of spaced non-tapered portions and said slot extending into a corresponding single non-tapered portion, said single non-tapered portion sized to fit between said spaced non-tapered portions.

19. A method of thermally processing a product using the thermal processing chamber of claim 1 comprising the steps of:
placing a product on said conveyor;
conveying said product within said processing chamber, said product being subjected to thermal conduction with said conveyor and to thermal convection from said thermally charged air, said thermally charged air impinging said product.

20. The method of claim 22 wherein said conveyor of said thermal processing chamber further comprises:
a plurality of thermal energy conducting slats, each of said slats comprises an elongated plate having a top planar surface and sides tapering to a lower surface and having a set of linking elements, each slat bounded at each end by a chain link, chain links on adjacent slats being pivotally connected one to another at a pivot point thereby joining said slats, the edges of the top surfaces of adjacent slats being in abutment and located at said pivot point;
a pair of sprockets mounted on a frame, said chain links mounted about said sprockets such that said slats form an endless loop; and
wherein said linking elements comprise a longitudinally extending bar and a corresponding slot, said bar being sized to fit within the slot of an adjacent slat and to move within the slot when adjacent slats pivot while travelling about said sprockets, said bar being mounted on a pair of spaced non-tapered portions and said slot extending into a corresponding single non-tapered portion, said single non-tapered portion sized to fit between said spaced non-tapered portions.
